(19) United States
(12) Patent Application Publication
(10) Pub. No.: US 2017/0286725 A1
(43) Pub. Date: Oct. 5, 2017

(54) PENETRATION DETECTION BOUNDARY HAVING A HEAT SINK

(71) Applicant: HEWLETT PACKARD ENTERPRISE DEVELOPMENT LP, Houston, TX (US)

(72) Inventor: John M. Lewis, Sunnyvale, CA (US)

(21) Appl. No.: 15/508,185

(22) PCT Filed: Apr. 14, 2015
(86) PCT No.: PCT/US2015/025805

§ 371 Date: Mar. 2, 2017

(51) Int. Cl. G06F 21/86; G06F 21/55; G06F 1/20

(52) U.S. Cl. CPC G06F 21/86; G06F 1/206; G06F 21/554; G06F 2221/034

(57) ABSTRACT

An apparatus includes a substrate and an integrated circuit that is mounted to the substrate. The substrate includes a penetration detection boundary to detect a penetration attack and a heat sink to dissipate thermal energy for the integrated circuit. The boundary includes metal layers and penetration detection traces. The ground traces are coupled together to form the heat sink.

### BACKGROUND

A given computer system (a data center, for example) that processes and/or stores sensitive data typically employs measures to protect the data from unauthorized access. For example, the computer system may process and/or store such sensitive information, as credit cardholder data, patient records, personnel information, intellectual property, and so forth.

The protective measures may guard against unauthorized access while the sensitive data is in motion (while the data is being communicated across communication channels, for example). For example, the computer system may encrypt data that is communicated across communication channels. The protective measures may further guard against access to cryptographic keys that are stored by the computer system and used by the system to encrypt/decrypt the sensitive data.

### BRIEF DESCRIPTION OF THE DRAWINGS

FIG. 1A is a perspective view of a secure key manager according to an example implementation.

FIG. 1B is an illustration of a circuit assembly of the secure key manager of FIG. 1A according to an example implementation.

FIG. 2 is an exploded perspective view of a portion of a circuit substrate of the circuit assembly of FIG. 1B illustrating a penetration detection boundary according to an example implementation.

FIG. 3 is a top view of an upper penetration detection layer of the penetration detection boundary according to an example implementation.

FIG. 4 is a top view of the substrate portion of FIG. 2 according to an example implementation.

FIG. 5 is a cross-sectional view taken along line 5-5 of FIG. 4 according to an example implementation.

FIG. 6 is a cross-sectional view taken along line 6-6 of FIG. 4 according to an example implementation.

FIG. 7 is a cross-sectional view taken along line 7-7 of FIG. 4 according to an example implementation.

FIG. 8 is a flow diagram depicting a technique to inhibit a penetration attack and dissipate thermal energy according to an example implementation.

FIG. 9 is a schematic diagram illustrating a data center according to an example implementation.

FIG. 10 is a schematic diagram illustrating an architecture of the secure key manager according to an example implementation.

### DETAILED DESCRIPTION

An electronic system that processes and/or stores sensitive data (data representing patient records, personnel records, credit cardholder information, banking information, intellectual property, and so forth) may store one or multiple security keys that are used by the electronic device to encrypt and decrypt the sensitive data while in transit. In this manner, the electronic system may communicate encrypted, sensitive data for internal communications within the electronic device (communications between the system's processing cores and memories, for example), as well as communicate encrypted, sensitive data in external communications between the system and other electronic systems.

For the purpose of encrypting and decrypting the sensitive data, the electronic system may use one or multiple cryptographic keys, called “security keys” herein. In this manner, the electronic system may store the security key(s) in one or more protected memories of the system. Because access to the security keys allows access to the underlying sensitive data, the electronic system may have a physical security barrier to prevent, or at least inhibit, unauthorized access to the stored key(s). For example, sensitive components electronic system, which store security key(s) may be enclosed by a locked, metal container, which forms at least part of a physical security barrier to guard against unauthorized access to the stored key(s). In this manner, the metal enclosure may have no open ports through which a tool (a probe, a punch through device, and so forth) may be inserted for such purposes as sensing electrical signals (representing the keys, for example), physically extracting memory storing security keys, and so forth.

The metal container still be vulnerable to a “penetration attack” on the electronic system. A penetration attack is a physical attack on an electronic system in which a tool is used to penetrate the system's physical security barrier for purposes of gaining access to information (such as one or multiple security keys) that is stored in the system. For example, the tool may contain a drill or punch to form a hole in the metal container (and/or other enclosure or security barrier) of the electronic system, and a probe may be inserted into the hole to sense one or multiple electrical signals of the electronic system for purposes of retrieving the security key(s). As another example, instead of using a probe, the penetration attack may employ the use of a tool to punch into an integrated circuit (IC) of the electronic system for purposes of extracting a semiconductor memory, which can be read to retrieve one or multiple security keys that are stored in the extracted memory.

Example implementations are disclosed herein in which an electronic system has a physical security barrier that contains one or multiple penetration detection boundaries. In this context, a penetration detection boundary defines a security border, or perimeter, for purposes of protecting sensitive information stored by corresponding sensitive components (memories, processors, and so forth) of the electronic system. Although the penetration detection boundary may be at least partially penetrated in a penetration attack against the electronic system, the boundary is constructed to alert the electronic system to the tampering for purposes of allowing the system to timely respond to and/or thwart the penetration attack. In this manner, in response to being alerted to a penetration attack, the electronic system may take appropriate corrective actions, such as actions involving alerting a system administrator; alerting security personnel; erasing the security key(s) before the key(s) are extracted; shutting down operations of the electronic system, and so forth.

In accordance with example implementations that are described herein, the penetration detection boundary has an integrated heat sink, which may offer such advantages as allowing relatively high heat producing components of the electronic system, such as microprocessor core-based components, to operate at the higher ends of their respective frequency ranges. In this manner, a challenge with protecting sensitive components of the electronic system by enclosing the components inside a metal container is that the container may limit the amount of thermal energy that may be removed from the components. Due the confined space that is created by the enclosure and the absence of ports in the enclosure, the volume of air that is available to otherwise remove component-generated thermal energy may be limited. The heat sink of the penetration detection boundary provides an additional heat transfer path to remove this thermal energy.

In accordance with example implementations, the penetration detection boundary is formed from a multiple layer circuit substrate (a printed circuit board (PCB), for example). In general, the circuit substrate contains electrically conductive metal layers (copper layers, for example) that are separated by intervening electrically nonconductive, or insulating, layers. In accordance with example implementations, the penetration detection boundary includes penetration detection traces, which are patterned traces (serpentine traces, for example) that are formed in multiple metal layers of the circuit substrate. Moreover, in accordance with example implementations, the heat sink is at least formed in part from ground trace segments that are embedded in the penetration detection traces (embedded in folds of the serpentine traces, for example). The ground trace segments of the heat sink are electrically coupled together.

The ground trace segments of the heat sink may be coupled together by vias, in accordance with example implementations. In general, a via is an electrically conductive member (a metal tube, a metal rivet, and so forth) that extends between metal layers of a multiple layer circuit substrate for purposes of electrically coupling together conductive traces. The via has one end that originates at a first metal layer of the circuit substrate, and the via has another end originates at a second metal layer of the substrate. The ends of the via may be soldered to the respective first and second metal layers to electrically couple the via to these layers. The via may pass through one or multiple intervening metal layers and one or multiple intervening insulating layers between the first and second metal layers. Moreover, one or multiple of the intervening metal layers may also be electrically coupled (by way of solder, for example) to the via. A via that has one end exposed on an outer surface of the circuit substrate and the other end hidden inside the substrate is called a “blind via.” A “buried via” is completely enclosed within the substrate.

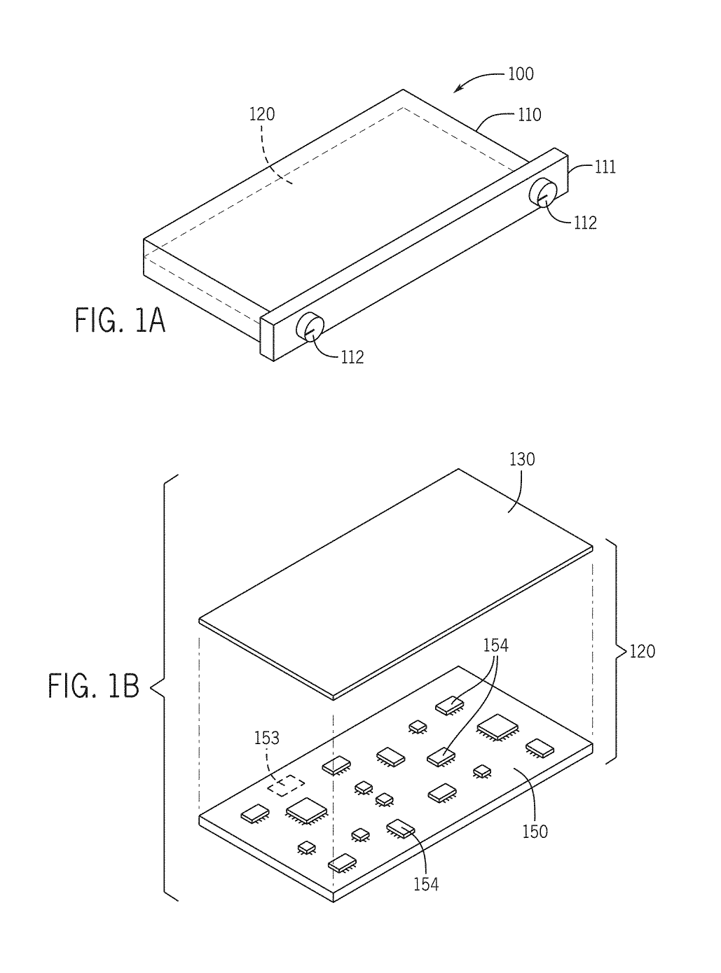

Referring to FIG. 1A, as a more specific example, an electronic system (a processor-based datacenter, for example) may contain one or multiple secure key managers, such as example secure key manager 100, for purposes of managing, protecting, serving and preserving security keys for the system. The secure key manager 100 may, in accordance with example implementations, be a blade that is constructed to be received in a backplane bus slot of a computer system rack.

The secure key manager 100 stores one or multiple security keys and has a physical security barrier that protects the sensitive components of the manager 100 (which part of a circuit assembly 120) against a penetration attack. As depicted in FIG. 1A, this physical security barrier may include an outer metal enclosure 110 that surrounds, or encloses, the circuit assembly 120.

In accordance with example implementations, the metal enclosure 110 may, in general, may have no ports, or openings, through which a penetration attack may occur (through which a punch through tool or probe may be inserted, for example) for purposes of gaining access to the security key(s) and/or other sensitive information stored inside the secure key manager 100. The secure key manager 100 may communicate with external circuitry using (as examples) connector sockets, optical signaling, inductive coupling connections, and so forth. The metal enclosure 110 may include various security mechanisms, such as (as an example) key locks 112, which secure the enclosure 110 from being opened (by removal of a front panel 111 of the enclosure 110, for example) except when two keys (keys held by two authorized employees, for example) are concurrently inserted and turned.

It is conceivable that a penetration attack may occur, which involves drilling, punching out, or other removing, material of the metal enclosure 110 to gain access to the circuit assembly 120. The circuit assembly 120, however, has one or multiple penetration detection boundaries to allow the secure key manager 100 to detect and respond to this type of penetration attack.

Referring to FIG. 1B, more specifically, in accordance with example implementations, the circuit assembly 120 includes an upper substrate 130 and a lower substrate 150, and each of the substrates 130 and 150 contains a penetration detection boundary. The penetration detection boundary, as its name implies, is a barrier that is constructed to provide an indication to the secure key manager 100 to alert the manager 100 when at least partial penetration of the boundary (i.e., detected tampering) occurs.

It is noted that references herein to direction and orientation, such as “upper” and “lower,” are used herein to describe the figures; and the substrates, circuit assemblies, layers, and so forth, may be used in a variety of orientations, depicting on the particular implementation. For example, the circuit assembly 130, in accordance with example implementations, may be used in an orientation that is flipped over or turned on its inside, relative to the orientation that is depicted in FIG. 1B.

For the example implementation of FIG. 1B, the lower substrate 150 may be a printed circuit board (PCB) substrate, and electronic components 154 (integrated circuits (ICs), for example) of the secure key manager 100 may be mounted on an upper surface of the substrate 150. As example, the electronic components 154 may contain one or multiple semiconductor memory devices that form a cryptographic processor; one or multiple semiconductor memory devices that store sensitive data and security keys; microprocessor core containing components; gate arrays; logic devices; resistors, capacitors; and so forth. Moreover, the electronic components 154 may perform various functions for the secure key manager 100, such as the functions of a key server; a key manager; a security monitor that detects and responds to a penetration attack; and so forth.

The lower substrate 150 is a multiple layer substrate. In this manner, the lower substrate 150 contains one or multiple metal layers that are configured to communicate power and signals for the electronic components 154. As described further herein in connection with an example section 153 of the substrate 150, the substrate 150 also contains metal layers that form a penetration detection boundary.

More particularly, in accordance with example implementations, the lower substrate 150 contains metal layers that form corresponding penetration detection layers. In this manner, the penetration detection layers of the lower substrate 150 are constructed (as described herein) to indicate when a penetration attack occurs. In particular, the penetration detection layers of the lower substrate may detect a penetration attack, originating from the bottom of the enclosure 110 (for the orientation of the secure manager 100 that is depicted in FIG. 1), for example). Moreover, as described herein, ground traces are integrated into the metal layers with the penetration detection layers; and these ground traces are electrically coupled together for purposes of forming a heat sink to remove thermal energy from the electronic components 154, such as the component(s) 154 containing microprocessor core(s).

The upper substrate 130, in accordance with example implementations, may be a flexible circuit (as an example), and may contain a penetration detection boundary that is formed from one or multiple penetration detection layers of the substrate 130. In this manner, the penetration detection boundary of the upper substrate 130 may be used to indicate when penetration of the substrate 130 occurs and as such, may be particularly beneficial for detecting a penetration attack that originates from the top of the metal enclosure 110 (for the orientation of the secure key manager 100 depicted in FIG. 1).

In accordance with an example implementation, the upper substrate 130 may be mechanically and electrically coupled to the lower substrate 150 for purposes of providing upper and lower penetration detection for the secure key manager 100. For example, a security monitor (formed from one or multiple electronic components 154) may be electrically coupled to the penetration detection boundaries of the upper 130 and lower 150 substrates 130 (via a conductive polymer connector, such as a zebra strip connector, for example) for purposes of detecting and responding to a penetration attack. Other implementations are contemplated, which are within the scope of the appended claims. For example, in accordance with further example implementations, the upper substrate 130 may be constructed from a flexible circuit that has a sufficient length to allow the substrate 130 to be wrapped around the substrate 150, so that the substrate 130 extends above and below the substrate 150.

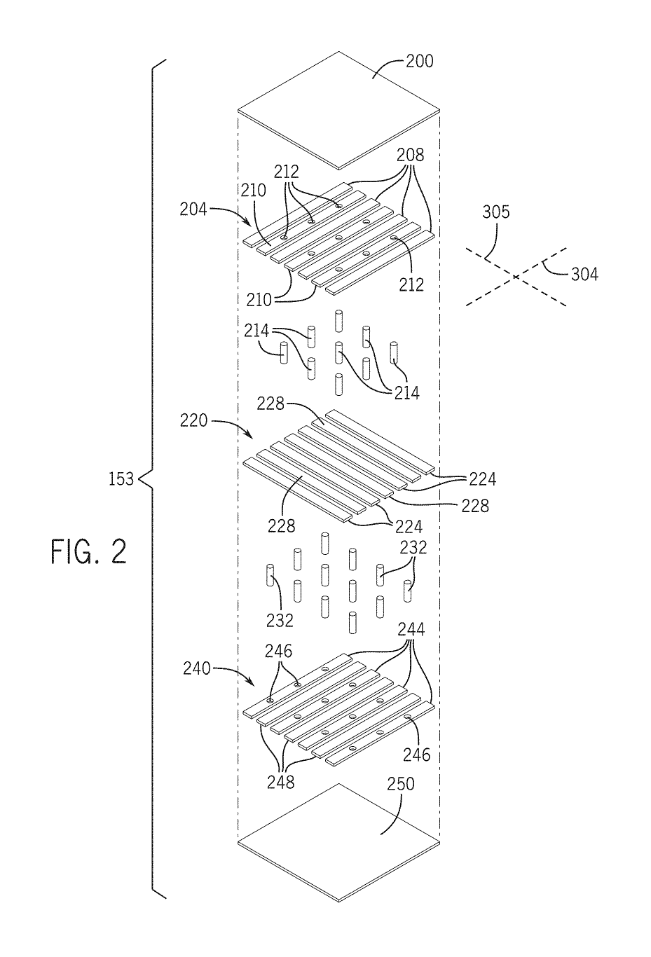

FIG. 2 depicts an example portion 153 (see FIG. 1B) of the lower substrate 150, illustrating the penetration detection barrier of the substrate 150, in accordance with example implementations. It is noted that the substrate 150 may contain layers other than the layers that are depicted in FIG. 2. For example, the lower substrate 150 may include one or multiple metal layers between, above and/or below any of the layers illustrated in FIG. 2, for purposes of communicating signals for the ICs (see FIG. 1B) of the substrate 150. As another example, the lower substrate 150 may contain one or multiple additional penetration detection layers. Thus, many variations are contemplated, which are within the scope of the appended claims.

Referring to FIG. 2 in conjunction with FIG. 1B, the lower substrate 150 includes an upper ground plane 200, which may be formed from the uppermost metal layer of the substrate 150, and a lower ground plane 250, which may be formed from the lowermost metal layer of the substrate 150. For the example implementation of FIG. 2, the substrate 150 also includes three penetration detection layers: an upper penetration detection layer 204; a middle penetration detection layer 220; and a lower penetration detection layer 240. Each penetration detection layer 204, 220 and 240, in turn, may be associated with a corresponding metal layer of the lower substrate 150.

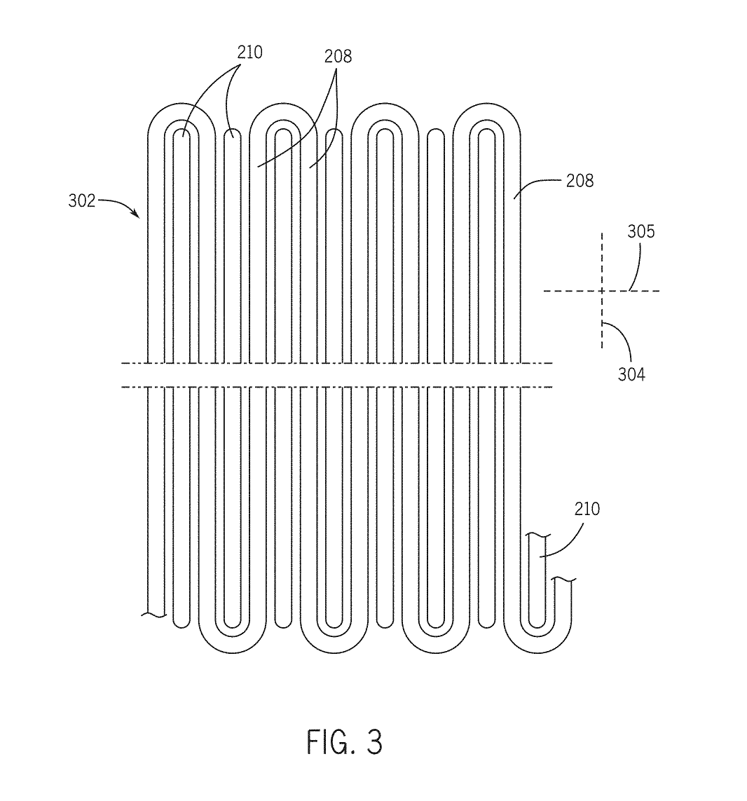

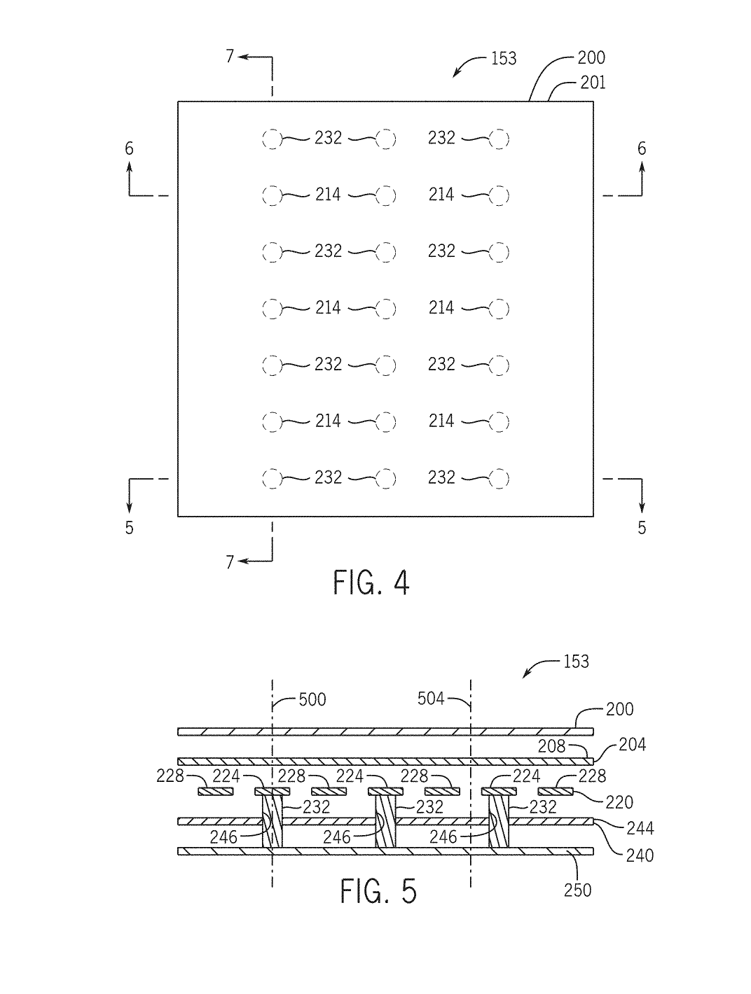

The upper penetration detection layer 204 includes at least one metal trace, which is arranged in a pattern to detect penetration of the layer 204. Referring to FIG. 3 in conjunction with FIG. 2, as a more specific example, a metal trace 302 of the upper penetration detection layer 204 may be arranged in a tortuous, or serpentine, path, which has parallel trace segments 208. As an example of how the metal trace 302 may be used to detect penetration, a security monitor (formed from one or multiple electronic components 154 (FIG. 1B)) may provide a signal to one end of the metal trace 302 and monitor a signal that appear on the other end of the trace 302.

If the metal trace 302 is broken or disrupted by a penetration, the security monitor may detect this event by observing that the monitored signal does not match the expected signal. The security monitor may provide signals to the metal trace 302, which vary over time and which may varying in a sequence so that the signal on the trace 302 may not be predicted. The traces and/or vias electrically coupling the metal trace 302 to the security monitor, as well as similar traces and/or vias electrically coupling other penetration detection metal traces to the security monitor are not shown in the figures.

Moreover, the upper penetration detection layer 204, as well as the other penetration detection layers 220 and 224, may have multiple tortuous traces that receive multiple signals for purposes of detecting layer penetration; and one or more of the traces may be arranged in patterns other than the serpentine pattern that is depicted in FIG. 3. Additionally, depending on the particular implementation, a given penetration detecting trace may extend locally beneath one or multiple electronic components 154, may extend from edge to edge of the lower substrate 150, and so forth. Thus, many variations are contemplated, which are within the scope of the appended claims.

For the example implementation of FIG. 3, the parallel penetration detection trace segments 208 of the upper penetration detection layer 204 are elongated along an elongation axis 304. As depicted in FIG. 2, in accordance with example implementations, the elongation directions associated with the penetration detection traces of the other penetration detection layers 220 and 224 may vary for purposes of ensuring that at least one of the layers is penetrated during a penetration attack. For example, as depicted in FIG. 2, trace segments of the upper 204 and lower 240 penetration detection layers may be elongated along the elongation axis 304; and trace segments of the middle penetration detection layer 220 may be elongated along an elongation axis 305, which is orthogonal to the axis 304.

FIG. 3 further depicts ground trace segments 210 that are embedded, or interwoven, into the folds of the metal trace 308. As depicted in FIGS. 2 and 3, the penetration detection trace segments 208 are parallel to each other and also parallel to the ground trace segments 210. As described below, the ground trace segments 210 are electrically coupled to the upper 200 and lower 250 ground planes, and are also coupled to ground trace segments that are embedded in the other penetration detection layers 220 and 240, for purposes of forming a heat sink that is integrated into the penetration detection boundary.

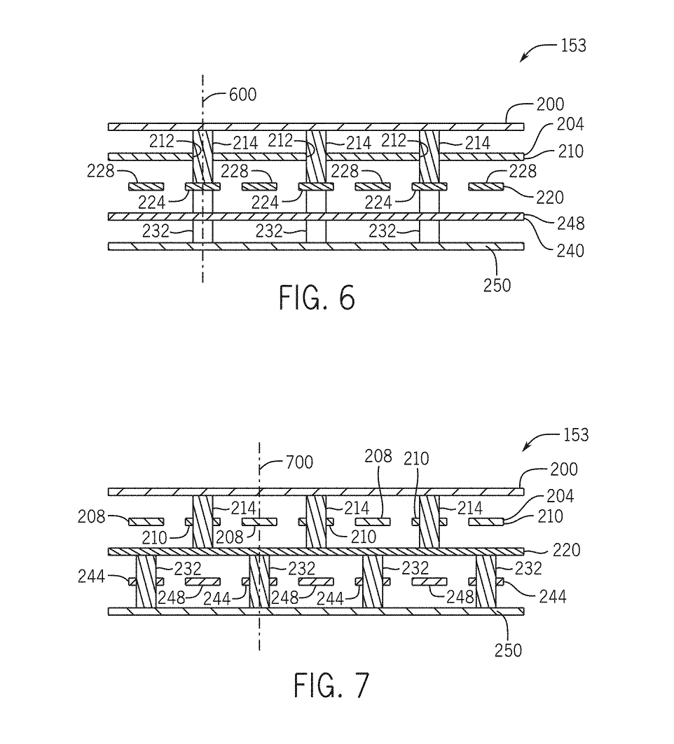

Referring to FIG. 2 in conjunction with FIG. 6, in accordance with example implementations, each ground trace segment 210 contains holes, or openings 212. In this regard, each opening 212 receives an associated buried via 214, which extends through the opening 212 to form an electrical coupling between the ground trace segment 210 and the upper ground plane 200.

The buried vias 214 further electrically couple embedded ground trace segments 228 of the middle penetration detection layer 220 to the ground trace segments 210 and upper ground plane 200. More specifically, in accordance with example implementations, the middle penetration detection layer 220 includes a penetration detection trace (a tortuous or serpentine trace, for example), which includes parallel trace segments 224. As depicted in FIG. 2, the penetration detection trace segments 228, for this example implementation, longitudinally extend along the elongation axis 305; and the ground trace segments 228 are embedded in folds of the penetration detection trace. Due to this arrangement, the ground trace segments 228 and interleaved with and parallel the penetration detection trace segments 224. Moreover, because the ground trace segments 228 of the middle penetration detection layer 220 are orthogonal to the ground trace segments 210 of the upper penetration detection layer 204, the segments 210 and 228 overlap, such that a given ground trace segment 228 is connected by multiple vias to multiple ground trace segments 210.

Referring to FIG. 2 in conjunction with FIG. 5, buried vias 232 extend from the middle penetration detection layer 220, through the lower penetration detection layer 240 and to the lower ground plane 250 for purposes of electrically coupling together the lower ground plane 250, embedded ground trace segments 244 of the lower penetration detection layer 240 and the ground trace segments 228 of the middle penetration detection layer 220. In this manner, the ground trace segments 244 have openings 246 through which corresponding vias 232 extend between the ground trace segments 228 and the lower ground plane 250. Because the ground trace segments 228 of the middle penetration detection layer 220 are orthogonal to the ground trace segments 244 of the lower penetration detection layer 240, the segments 228 and 244 overlap, such that a given ground trace segment 228 is connected by multiple vias 232 to multiple ground trace segments 244.

Thus, overlapping ground trace segments, in combination with the buried vias 214 and 232 electrically couple together the embedded ground trace segments of the penetration detection layers 204, 220 and 240 to form a heat sink. Moreover, the heat sink capacity is further enhanced due to the coupling of the ground trace segments to the ground planes 200 and 250, in accordance with example implementations.

The penetration detection traces of the layers 204, 220 and 240 are offset with respect to each other for purposes of ensuring that a penetration attack through or into the lower substrate 150 extends through at least one penetration detection trace. Moreover, the ground trace segments of the layers 204, 220 and 240 are arranged in a manner to preclude a penetration attack pathway through the ground elements (ground planes, ground trace elements and connecting vias) which may otherwise avoid the penetration detection layers.

As examples, FIGS. 5, 6 and 7 depict hypothetical penetration pathways that extend through one of the vias 214 and 232 to bypass one of the penetration detection layers. However, due to the manner in which the ground trace segments are arranged, each of the pathways intersects a penetration detection trace. In this manner, referring to FIG. 5, for a hypothetical penetration along pathway 500, the penetration extends through penetration detection trace segment 208 of the upper penetration detection layer 204.

For a hypothetical penetration along pathway 504, the penetration extends through penetration detection trace segment 244 of the upper penetration layer 204. Referring to FIG. 6, a hypothetical penetration along pathway 600 penetrates penetration detection trace 248 of the lower penetration detection layer 240. Referring to FIG. 7, a hypothetical penetration along pathway 700 penetrates penetration detection trace 208 of the upper penetration detection layer 204.

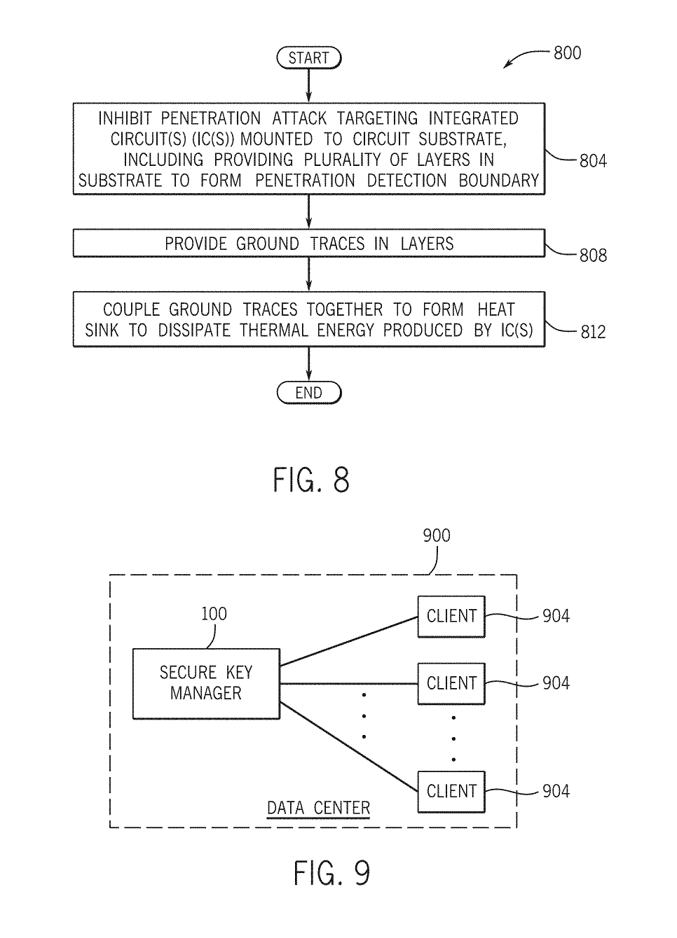

Referring to FIG. 8, to summarize, in accordance with example implementations, a technique 800 includes inhibiting a penetration attack that targets one or multiple integrated circuits (ICs) that are mounted to a circuit substrate, including providing a plurality of layers in the substrate to form a penetration detection boundary, pursuant to block 804. The technique 800 includes providing (block 808) ground traces within the penetration detection boundary and coupling (block 812) the ground traces together to form a heat sink to dissipate thermal energy produced by one or more of the ICs.

In accordance with example implementations, the secure key manager 100 may be part of a data center 900, in which the secure key managing server 910 manages, stores and serves keys for one or multiple clients 920 of the data center 900. As an example, the secure key manager 100 and clients 904 may be blades that are inserted into one or more racks of the data center 900.

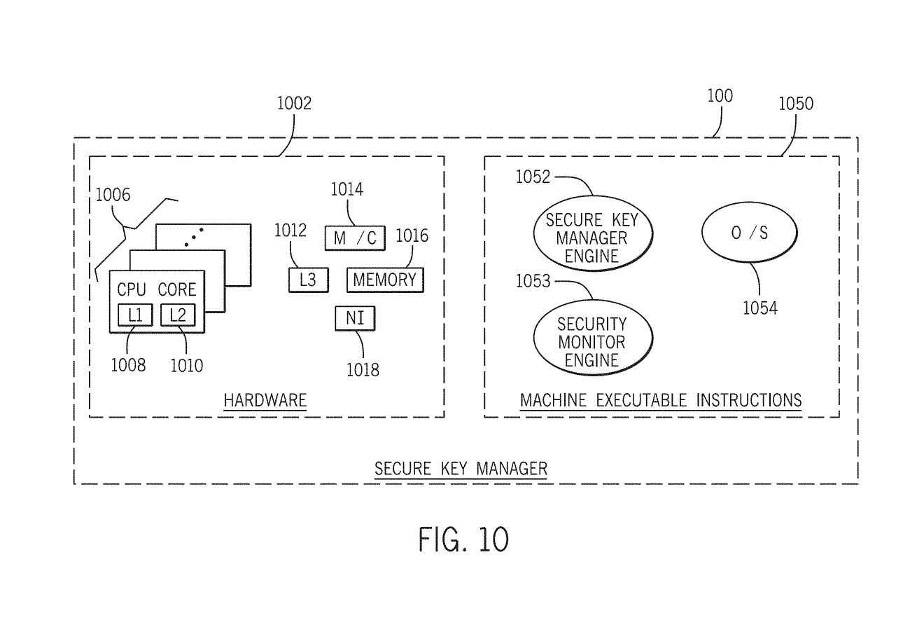

In accordance with example implementations, the secure key manager 100 may have an architecture that is schematically represented in FIG. 10. In general, the secure key manager 100 may include hardware 1002 and machine executable instructions, or “software,” 1050. In general, the hardware 1002 may be formed from the electronic components 154 (see FIG. 1B) and may include one or multiple central processing unit (CPU) cores 1006. In accordance with example implementations, each CPU core 1006 may include onboard memory, such as level one (L1) cache 1008 and a level two (L2) cache 1010.

The hardware 1002 may also include memory that is accessed by the CPU core(s) 1006, such as a level three (L3) cache 1012 and a system memory 1016. In accordance with an example implementation, a given set of one or multiple CPU cores 1006 may form a cryptographic processor, and at least one secure key may be stored in of this cryptographic processor (in a memory of the processor, such as in an L1 or L2 cache of the processor, for example).

The hardware 1002 may include other and/or different components than the components that are depicted in FIG. 10 in further example implementations, such as a memory controller 1014, a network interface 1018, and so forth.

The software 1050 may include a set of machine executable instructions that, when executed by one or multiple CPU core(s) 1006, cause the CPU core(s) 1006 to form a secure key manager engine 1052 to manage, serve and protect keys as well as perform various cryptographic ciphers. The software 1050 may include a set of machine executable instructions that, when executed by one or multiple CPU core(s) 1006, cause the CPU core(s) 1006 to form a security monitor engine 1053 to provide signals to the penetration detection traces, receive signals from the penetration detection traces to detect a penetration attack, take corrective action in response to detecting a penetration attack, and so forth. The software 1050 may include different and/or other machine executable instructions that when executed may form various other software components, such as an operating system 1054, device drivers, applications and so forth.

Other implementations are contemplated, which are within the scope of the appended claims. For example, in accordance with further example implementations, a heat sink structure (a metal, finned heat sink structure, for example), may be mounted to one or both of the ground planes 200 and 250 (see FIG. 2) for purposes of further enhancing the removal of thermal energy from the heat dissipating electronic components. As another variation, at least some of the ground trace segments of the penetration detection boundary may be formed in a metal layer that does not include a penetration detection trace (a layer between two penetration detection layers, for example). In further example implementations, the penetration detection boundary and its heat sink may be used in system other than a system that is part of a data center. In further example implementations, the penetration detection boundary and its heat sink may be used in an electronic device other than a secure key manager and may be used to detect a penetration attack for purposes other than protecting security keys or sensitive data. In further example implementations, the penetration detection boundary and its heat sink may include more than three metal layers. While the present techniques have been described with respect to a number of embodiments, it will be appreciated that numerous modifications and variations may be applicable therefrom. It is intended that the appended claims cover all such modifications and variations as fall within the scope of the present techniques.

What is claimed is:

1. An apparatus comprising:
a substrate; and
an integrated circuit mounted to the substrate,
wherein:
the substrate comprises a penetration detection boundary to detect a penetration attack and a heat sink to dissipate thermal energy for the integrated circuit;
the boundary comprises a plurality of metal layers associated with the substrate, and the boundary comprising ground traces and penetration detection traces; and
the ground traces are coupled together to form the heat sink.

2. The apparatus of claim 1, wherein the integrated circuit comprises a microprocessor core.

3. The apparatus of claim 1, wherein the plurality of metal layers comprise a first metal layer, a second metal layer and a third metal layer, the apparatus further comprising:
a first set of vias to extend between the first and second metal layers to electrically couple together ground traces associated with the first and second metal layers; and
a second set of via offset from the first set of vias to extend between the second and third metal layers and electrically couple together the second and third ground traces together.

4. The apparatus of claim 3, further comprising:
another metal layer associated with the substrate to form a ground plane,
wherein one of the first and second set of vias extend to the ground plane.

5. The apparatus of claim 1, wherein for at least one of the metal layers, at least one ground trace of the plurality of ground traces is embedded in a penetration detection trace of the plurality of penetration detection traces.

6. The apparatus of claim 1,
the plurality of metal layers comprise a first metal layer and a second metal layer;
the ground trace associated with the first metal layer is arranged in a pattern, and the pattern having a first orientation; and
the ground trace associated with the second metal layer is arranged in the pattern, and the pattern having a second orientation different from the first orientation.

7. A method comprising:
inhibiting a penetration attack targeting at least one integrated circuit mounted on a substrate, wherein inhibiting the penetration attack comprises providing a plurality of layers in the substrate to form a penetration detection boundary;
providing ground traces within the penetration detection boundary; and
coupling the ground traces together to form a heat sink to dissipate thermal energy produced by at least one integrated circuit mounted on the substrate.

8. The method of claim 7, further comprising:
coupling the ground traces together using vias; and
routing the ground traces and vias such that a penetration attack along a pathway extending through a given via also extends through at least one of the penetration detection layers.

9. The method of claim 7, wherein:
the ground traces comprise sets of ground traces, the ground traces of each set being parallel to each other and being embedded in a different layer of the layers of the penetration detection boundary; and
providing the ground traces comprises routing a given ground trace of at least one of the ground traces such that the given ground trace overlap multiple ground traces of another one of the sets.

10. The method of claim 8, wherein coupling the ground traces comprises providing vias to couple the given ground trace to the multiple ground traces overlapped by the given ground trace.

11. The method of claim 7, wherein the providing the ground traces comprises embedding at least some of the ground traces in at least one layer of the penetration detection boundary.

12. A system comprising:
a processor to store at least one security key; and
a substrate comprising:
a first metal layer to communicate signals for the processor; and
a plurality of additional metal layers, wherein each of the plurality of additional metal layers comprise an associated trace arranged in a tortuous pattern to detect penetration of the metal layer and an associated ground trace; and
vias to electrically couple to the ground traces together to form a heat sink to dissipate power for the processor.

13. The system of claim 12, further comprising a circuit coupled to provide a signal to at least one of the traces arranged in a tortuous pattern and detect interruption of the signal to detect penetration of the associated metal layer.

14. The system of claim 12, further comprising another metal layer comprising a ground plane, wherein at least one of the vias electrically couples the ground plane and the ground traces together.

15. The system of claim 12, wherein:
the tortuous pattern comprises folds; and
at least some of the ground traces are disposed in the folds.
